(19) United States
(12) Patent Application Publication
(10) Pub. No.: US 2014/0176815 A1
(43) Pub. Date: Jun. 26, 2014

(54) Video Projection Device and Video Display Device

(71) Applicant: Funai Electric Co., Ltd., Osaka (JP)

(72) Inventors: Kenji Nagashima, Osaka (JP); Atsushi Kitamoto, Osaka (JP)

(73) Assignee: Funai Electric Co., Ltd., Osaka (JP)

(21) Appl. No.: 14/104,373

(22) Filed: Dec. 12, 2013

(30) Foreign Application Priority Data
Dec. 26, 2012 (JP) 2012-283245

(51) Int. Cl. H04N 9/31; G02B 26/10

(52) U.S. Cl. CPC H04N 9/3141; G02B 26/101
USPC 348/744

(57) ABSTRACT

A video projection device has a video output unit for outputting video by emitting light, and a reflective mirror for reflecting the light emitted from the video output unit to project the video on a projection target. The reflective mirror is driven to rotate about two axes so as to move the reflected light in the horizontal and vertical directions.

This application is based on Japanese Patent Application No. 2012-283245 filed on Dec. 26, 2012, the contents of which are hereby incorporated by reference.

### BACKGROUND OF THE INVENTION

1. Field of the Invention

The present invention relates to video projection devices.

2. Description of Related Art

There have conventionally been proposed a variety of video projection devices for projecting video on large screens.

For example, Japanese Patent Application Publication No. H11-90038 discloses a game machine that employs a color video projector to project video on a large screen installed in front of the wind shield of an automobile.

Inconveniently, however, projecting video from the just mentioned conventional projector to the large screen requires a large space with no obstacle between the projector and the projection surface, and projecting video on the screen with desired brightness requires that the projector produce considerably high brightness.

### SUMMARY OF THE INVENTION

An object of the present invention is to provide a video projection device that does not require a large space between itself and the projection target, and that can display video with desired brightness even with a low-brightness video output.

According to one aspect of the present invention, a video projection device is provided with: a video output unit for outputting video by emitting light; and a reflective mirror for reflecting the light emitted from the video output unit to project the video on a projection target, the reflective mirror being driven to rotate about two axes so as to move the reflected light in the horizontal and vertical directions.

With this configuration, no large space is required between the video projection device and the projection target, and even with a low-brightness video output, by limiting the projection area, it is possible to project video on the projection target with desired brightness, and to move the projected video across the projection target. Thus, a user can feel as if a moving image were displayed.

In the configuration described above, the video output unit may output the video by two-dimensionally scanning and emitting the light.

With this configuration, even when the projection distance from the reflective mirror to the projection target varies, no defocus occurs. Moreover, just for the sake of discussion, even in a case where the projection target has the shape of a flat plate having a solid object formed on it, no defocus occurs.

In the configuration described above, the video output unit may output the video while refreshing frames, and twice the number of revolutions per second of the reflective mirror in the horizontal and vertical directions may be equal to or less than the refresh rate of the frames.

With this configuration, the time required for the reflective mirror to rotate 180° in the horizontal and vertical directions is equal to or longer than the time required to refresh a frame. Thus, it is possible to suppress unnatural display.

In any of the configurations described above, there may be further provided a corrector for correcting at least one of the magnification, distortion, and brightness of the video output from the video output unit according to the projection position of the video.

With this configuration, it is possible to make at least one of the magnification and distortion of the projected video substantially uniform. Moreover, it is possible to suppress variation in the brightness of the projected video depending on the projection position.

In the configuration described above, the video output unit may include a horizontal mirror for scanning the emitted light in the horizontal direction and a vertical mirror for scanning the emitted light in the vertical direction, and the corrector may correct at least one of the magnification and distortion of the video by controlling deflection of the horizontal and vertical mirrors.

In any of the configurations described above, the video output unit may include a horizontal mirror for scanning the emitted light in the horizontal direction and a vertical mirror for scanning the emitted light in the vertical direction, and there may be further provided a light detector for detecting the light reflected from the reflective mirror and then reflected from an obstacle, and a position detector for detecting the position of the obstacle in the projected video based on horizontal and vertical synchronizing signals for driving the horizontal and vertical mirrors at the time that the light detector detects the light.

With these configurations, when a user puts an obstacle into the projected video, the position of the obstacle is detected; thus, an operation corresponding to the detected position can be performed. Thus, it is possible to realize a virtual input interface.

According to another aspect of the present invention, a video display device is provided with: the video projection device according to any of the configurations described above; and a projection target arranged with a displacement, in the direction perpendicular to the projection surface, from the position of the reflective mirror provided in the video projection device. With this configuration, it is possible to more reliably direct the light reflected from the reflective mirror to the projection surface to project video.

In the configuration described above, the reflective mirror may be arranged with a displacement from the projection target, which is of a reflective type, such that the light reflected from the reflective mirror is incident on the projection surface.

With this configuration, the video projected from the reflective mirror is more reliably reflected on the projection target, allowing a user to visually recognize the projected image.

In the configuration described above, the projection target may include elements arranged in a matrix and switchable between cloudy (whitish, opaque) and transparent states, and there may be further provided a driver for driving part of the elements into the cloudy state while changing the part within the matrix according to the position of the projected video.

In the configuration described above, by projecting video on cloudy elements, it is possible to display the image clearly, and as the position of the projected video changes, the position of the elements which are made cloudy changes, producing a striking visual effect.

### BRIEF DESCRIPTION OF THE DRAWINGS

FIG. 1 is a schematic overall perspective view of a pachinko machine according to a first embodiment of the present invention;

FIG. 2 is a block diagram of a video projection device according to the first embodiment of the present invention;

FIG. 3 is a schematic perspective view of a biaxial mirror unit according to the first embodiment of the present invention;

FIG. 4 is a schematic overall perspective view of a pachinko machine according to a second embodiment of the present invention;

FIG. 5 is a view of a light detection unit according to the second embodiment of the present invention, as seen from the side of its light-receiving surface; and

FIG. 6 is a block diagram of a video projection device including the light detection unit according to the second embodiment.

### DETAILED DESCRIPTION OF PREFERRED EMBODIMENTS

### First Embodiment

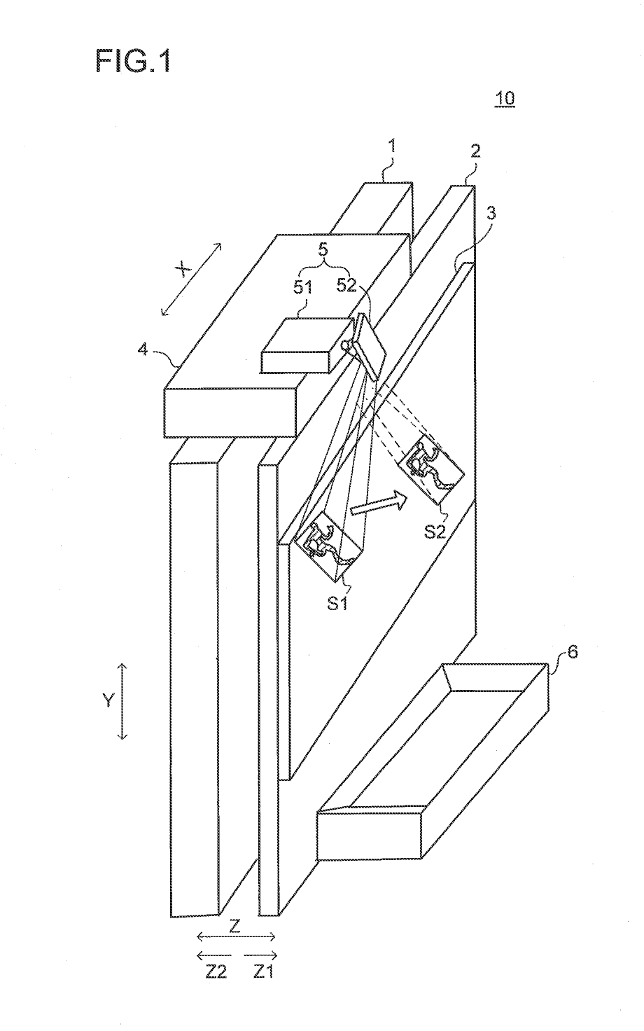

Hereinafter, an embodiment of the present invention will be described with reference to the accompanying drawings. The following description deals with an example where the present invention is applied to a pachinko machine. A schematic overall perspective view of a pachinko machine according to a first embodiment of the present invention is shown in FIG. 1. In FIG. 1, the horizontal direction is referred to as X direction, the vertical direction is referred to as Y direction, and the depth direction is referred to as Z direction (with Z1 direction pointing frontward and Z2 direction pointing rearward).

The pachinko machine 10 shown in FIG. 1 is provided with a machine body 1, a glass plate 2, a screen 3, a base 4, a video projection device 5, and a tray 6.

The machine body 1 is provided with, inside a cabinet, a ball launcher which launches pachinko balls, a pachinko board onto which the pachinko balls are launched, etc. (none is illustrated), and the pachinko board is disposed so as to be visible from the front face side of the machine body 1 (from the Z1 direction in FIG. 1).

On the front side of the machine body 1, the glass plate 2 is disposed, and the screen 3 is disposed so as to cover part of the front face of the glass plate 2. The screen 3 is a reflective screen, and permits a user located on the front face side of the screen 3 to view an image reflected on a projection surface of the screen 3. Under the screen 3, the tray 6 is disposed to collect pachinko balls.

On the top face of the cabinet of the machine body 1 and on the top face of the glass plate 2, the base 4 is mounted. Mounted on and fixed to the base 4 is the video projection device 5, which includes a video output unit 51 and a biaxial mirror unit 52.

The video output unit 51 is a video output device of a laser scanning type, and its housing is fixed on the top surface of the base 4.

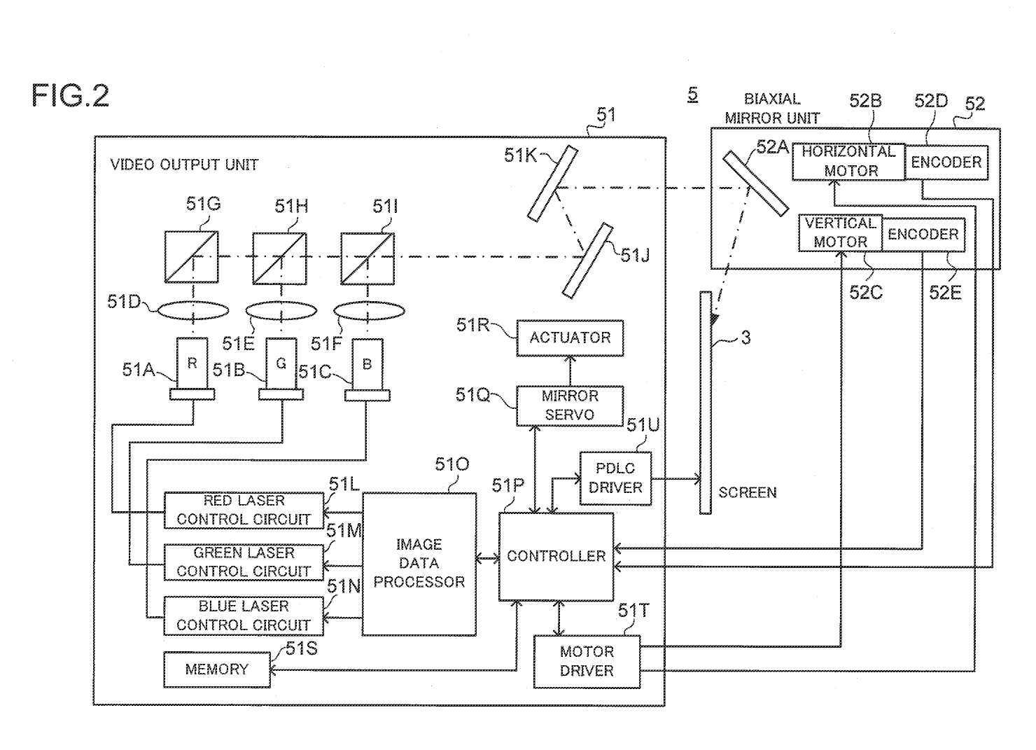

The block configuration of the video output unit 51 is shown in FIG. 2. As shown in FIG. 2, the video output unit 51 is provided with a red LD (laser diode) 51A, a green LD 51B, a blue LD 51C, collimator lenses 51D to 51F, beam splitters 51G to 51I, a horizontal MEMS (microelectromechanical system) mirror 51J, a vertical MEMS mirror 51K, a red laser control circuit 51L, a green laser control circuit 51M, a blue laser control circuit 51N, an image data processor 51O, a controller 51P, a mirror servo 51Q, an actuator 51R, a PDLC driver 51U, a motor driver 51T, and a memory 51S.

The red LD 51A emits red laser light at a power controlled by the red laser control circuit 51L. The emitted red laser light is made into a parallel beam by the collimator lens 51D, is then reflected on the beam splitter 51G, and is then transmitted through the beam splitters 51H and 51I to be directed to the horizontal MEMS mirror 51J.

The green LD 51B emits green laser light at a power controlled by the green laser control circuit 51M. The emitted green laser light is made into a parallel beam by the collimator lens 51E, is then reflected on the beam splitter 51H, and is then transmitted through the beam splitter 51I to be directed to the horizontal MEMS mirror 51J.

The blue LD 51C emits blue laser light at a power controlled by the blue laser control circuit 51N. The emitted blue laser light is made into a parallel beam by the collimator lens 51F, and is then reflected on the beam splitter 51I to be directed to the horizontal MEMS mirror 51J.

The laser light thus incident on and reflected from the horizontal MEMS mirror 51J, which can so deflect the laser light as to scan it in the horizontal direction, is then incident on and is reflected from the vertical MEMS mirror 51K, which can so deflect the laser light as to scan it in the vertical direction, and then travels out of the housing of the video output unit 51.

By being deflected by the horizontal and vertical MEMS mirrors 51J and 51K, the laser light emanating from the video output unit 51 is scanned two-dimensionally.

Image data is stored in the memory 51S. As the memory 51S, for example, a ROM may be used so that image data is stored in the ROM. As the memory 51S, for example, a rewritable flash memory may be used so that image data input from outside the video output unit 51 is stored in the flash memory.

Image data in the memory 51S is read out by the controller 51P, and is converted by the image data processor 51O into data of three colors, namely red (R), green (G), and blue (B). The converted data is then transmitted to the red, green, and blue laser control circuits 51L, 51M, and 51N respectively.

The mirror servo 51Q drives the actuator 51R according to a horizontal synchronizing signal from the controller 51P to deflect the horizontal MEMS mirror 51J, and drives the actuator 51R according to a vertical synchronizing signal from the controller 51P to deflect the vertical MEMS mirror 51K. The horizontal synchronizing signal is, for example, a signal having a saw- tooth waveform, and the vertical synchronizing signal is, for example, a signal having a stepped waveform.

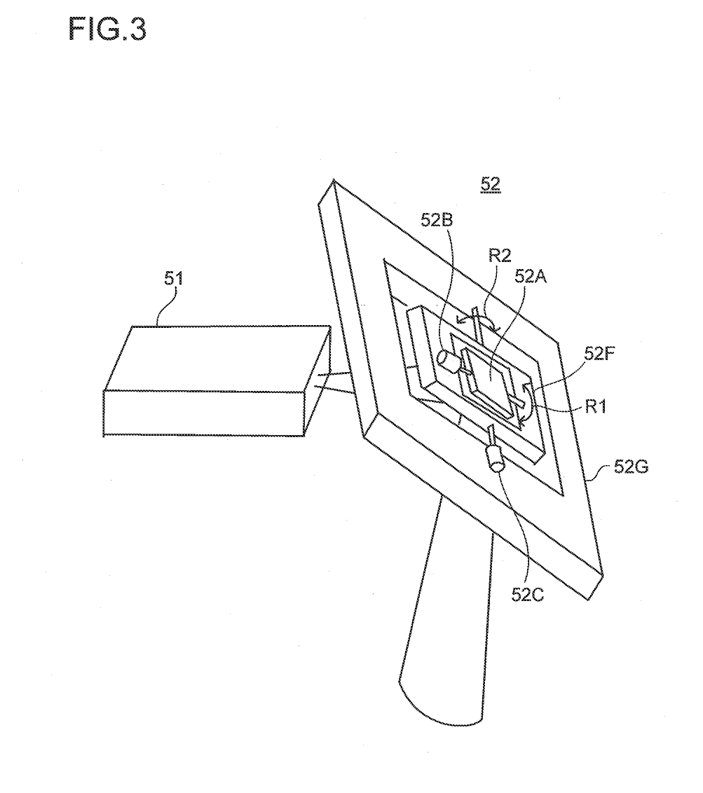

A schematic perspective view of the biaxial mirror unit 52 is shown in FIG. 3 (the block configuration of the biaxial mirror unit 52 is shown in FIG. 2). The biaxial mirror unit 52 is arranged forward of the video output unit 51, and is fixed to the housing of the video output unit 51 via a fitting member (unillustrated).

The biaxial mirror unit 52 is provided with a reflective mirror 52A which totally reflects the laser light emanating from the video output unit 51. A horizontal motor 52B drives the reflective mirror 52A to rotate (in R1 direction in FIG. 3) so as to move the light reflected from the reflective mirror 52A in the horizontal direction.

So that the laser light emanating from the video output unit 51 and reflected from the reflective mirror 52A can be directed to and projected on the projection surface of the screen 3, the reflective mirror 52A is arranged with a frontward displacement from the projection surface of the screen 3 (in the direction perpendicular to the projection surface). The horizontal motor 52B is fitted with an encoder 52D (FIG. 2) for detecting the rotation angle.

The reflective mirror 52A, the horizontal motor 52B, and the horizontal motor 52B are fixed to a base 52F so that these together form a single unit, which is driven to rotate by a vertical motor 52C. The vertical motor 52C drives the reflective mirror 52A to rotate in such a rotation direction (in R2 direction in FIG. 3) as to move vertically the light reflected from the reflective mirror 52A. The vertical motor 52C is fitted with an encoder 52E (FIG. 2) for detecting the rotation angle.

The vertical motor 52C is fixed to a base 52G. The base 52G is fitted to the housing of the video output unit 51 via a fitting member (unillustrated).

The horizontal motor 52B and the vertical motor 52C are driven and controlled by the controller 51P via the motor driver 51T (FIG. 2).

The image formed by the laser light emanating from, while being two-dimensionally scanned by, the video output unit 51 is reflected on the reflective mirror 52A, which is driven to rotate about two axes as described above, so as to be projected on the projection surface of the screen 3. As a result, a projected image of which the projection region is limited to part of the projection surface of the screen 3 moves across the projection surface. For example, in FIG. 1, the projected image moves from projected image S1 to projected image S2. Thus, a user viewing the screen 3 can feel as if a moving image were displayed.

Moreover, no large space is required between the video projection device 5 and the screen 3, and even with a video projection device 5 that produces a low-brightness output, by limiting the projection region, it is possible to move an image projected with desired brightness to desired positions across the entire area of a large screen 3.

Moreover, owing to the use of the video output unit 51 of a laser scanning type, even when the projection distance from the reflective mirror 52A to the screen 3 varies, no defocus as in common projectors occurs in the projected image. Furthermore, even in a case where an image is projected, for example, on the glass plate 2 as well as on a screen 3 as a solid object arranged on the glass plate 2, no defocus occurs.

In a case where the image data stored in the memory 51S is data of a moving image, the moving image is projected from the video output unit 51 while frames are (the screen is) refreshed. In this case, the reflective mirror 52A is controlled to deflect in the horizontal and vertical directions at positions and speed that match the moving image. In this way, it is possible to display a dynamic moving image on the screen 3.

To suppress unnatural display, it is preferable that the time required for the reflective mirror 52A to rotate 180° in the horizontal and vertical directions be equal to or longer than the time required to refresh a frame, that is, that twice the number of revolutions per second of the reflective mirror 52A in the horizontal and vertical directions be equal to or less than the refreshing rate of frames.

The image data may be image data of a still image. In that case, a single frame is projected, while constantly refreshed by itself, from the video output unit 51, and is then reflected on the reflective mirror 52A, which deflects about two axes, so as to be projected on the screen 3. This also permits a user viewing the screen 3 to feel as if a moving image were displayed on the screen 3.

The screen 3 will now be described more specifically. The screen 3 is a reflective screen composed of a large number of reverse PDLC (polymer dispersed liquid crystal) elements arrayed in a matrix. A reverse PDLC element is a liquid crystal element that is transparent with no voltage applied to it but becomes cloudy (whitish, opaque) with a voltage applied to it. With the PDLC elements transparent, the pachinko board in the machine body 1 is visible through the glass plate 2 disposed behind the screen 3. With the PDLC elements cloudy, a user can clearly see an image projected on them.

As shown in FIG. 2, application of a voltage to the individual PDLC elements constituting the screen 3 is controlled by the PDLC driver 51U. The PDLC driver 51U applies a voltage to, and make cloudy, only those PDLC elements which are located at the part of the matrix where the image is projected from the reflective mirror 52A, while applying no voltage to the other PDLC elements to leave them transparent. By projecting an image on cloudy PDLC elements, it is possible to display the image clearly. Moreover, as the projected image moves, the part of the PDLC elements which are made cloudy changes, producing a striking visual effect.

For example, in the case of an image of a person who is running, like projected images S1 and S2 in FIG. 1, the video output unit 51 only scans and outputs the image inside the outline of the person (images S1 and S2 excluding the rectangular frame), and only part of the PDLC elements, specifically those at which the corresponding image is projected from the reflective mirror 52A on the screen 3, are made cloudy. In this way, it is possible to clearly display the person as if running across the screen 3. Needless to say, an image including the background around the person (such as images S1 and S2 including the rectangular frame) may be projected.

Such control is also possible in which, while an image is being projected, the PDLC elements over the entire screen 3 are kept cloudy and, while no image is being projected, the PDLC elements over the entire screen 3 are left transparent. It is also possible to use PDLC elements that behave toward the presence or absence of voltage application in the opposite way to reverse PDLC elements.

As the screen 3, for example, instead of PDLC elements, a diffraction grating-type plate of which the transmittance and reflectance vary according to the direction of incidence of light may be used.

Depending on the projection position on the screen 3, the projected image may have varying magnifications and varying amounts of distortion. To cope with that, in this embodiment, where the projection position can be identified based on the rotation angles of the reflective mirror 52A in the horizontal and vertical directions as detected by the encoders 52D and 52E, the controller 51P corrects the magnification and distortion of the image output from the video output unit 51 according to the rotation angles detected by the encoders 52D and 52E (reverse correction of the image).

Correction of magnification and distortion can be achieved by controlling the deflection of the horizontal and vertical MEMS mirrors 51J and 51K. It may instead be achieved through image processing by the image data processor 51O. In this way, it is possible to make the magnification and distortion of the projected image uniform irrespective of the projection position.

Depending on the projection position on the screen 3, the brightness of the projected image also varies. To cope with that, in this embodiment, the controller 51P also corrects the brightness of the image output from the video output unit 51 according to the rotation angles detected by the encoders 52D and 52E.

Correction of brightness can be achieved through image processing by the image data processor 51O. Correction of brightness may instead be achieved through control in which the peak power of the laser light is varied by the red, green, and blue laser control circuit 51L, 51M, and 51N. In this way, it is possible to suppress variation in the brightness of the projected image depending on the projection position.

Incidentally, with consideration given to the fact that the projection distance varies within the projected image, brightness may be adjusted within the projected image.

As described above, in this embodiment, the video projection device 5 is provided with a video output unit 51 which outputs video by emitting light, and a reflective mirror 52A which reflects the light emitted from the video output unit 51 to project the video on a screen 3 while being driven to rotate about two axes so as to move the reflected light in horizontal and vertical directions. With this configuration, no large space is required between the video projection device 5 and the screen 3, and even with a low-brightness video output, by limiting the projection area, it is possible to project video on the screen 3 with desired brightness, and to move the projected video across the screen 3. Thus, a user can feel as if a moving image were displayed.

Moreover, in this embodiment, the video output unit 51 outputs the video by two- dimensionally scanning and emitting light. With this configuration, even when the projection distance from the reflective mirror 52A to the screen 3 varies, no defocus occurs. Moreover, just for the sake of discussion, even in a case where the projection target is shaped such that a screen 3 as a solid object is formed on a glass plate 2 as a flat plate, no defocus occurs.

Moreover, in this embodiment, the video output unit 51 outputs the video while refreshing frames, and the reflective mirror 52A is driven to rotate while one frame is scanned. Here, twice the number of revolutions per second of the reflective mirror 52A in the horizontal and vertical directions is equal to or less than the refresh rate of frames. In the case of the example of arrangement of the biaxial mirror unit 52 shown in FIG. 1, the rotation angle of the reflective mirror 52A does not exceed 180° either in the horizontal or vertical direction. If the time required for the reflective mirror 52A to rotate 180° at the maximum in the horizontal and vertical directions is shorter than the time required to refresh a frame, the reflective mirror 52A completes its rotation in the horizontal and vertical directions before completion of projection of video corresponding to one frame. It is then impossible to produce an effect of making the projected image appear to be moving according to the motion of the moving image. By making the time required for the reflective mirror 52A to rotate 180° in the horizontal and vertical directions equal to or longer than the time required to refresh a frame, it is possible to suppress unnatural display.

Moreover, in this embodiment, the magnification, distortion, and brightness of the video output from the video output unit 51 is corrected according to the projection position of the video. With this configuration, it is possible to make the magnification and distortion of the projected video uniform irrespective of the projection position. It is also possible to suppress variation in the brightness of the projected video depending on the projection position.

Moreover, in this embodiment, the screen 3 is composed of PDLC elements arranged in a matrix and switchable between an cloudy state and a transparent state, and part of the PDLC elements are driven into the cloudy state while the part is changed within the matrix according to the position of the projected video. Thus, by projecting video on cloudy PDLC elements, it is possible to display the image clearly, and as the position of the projected video changes, the position of the part of the PDLC elements which are made cloudy changes, producing a striking visual effect.

### Second Embodiment

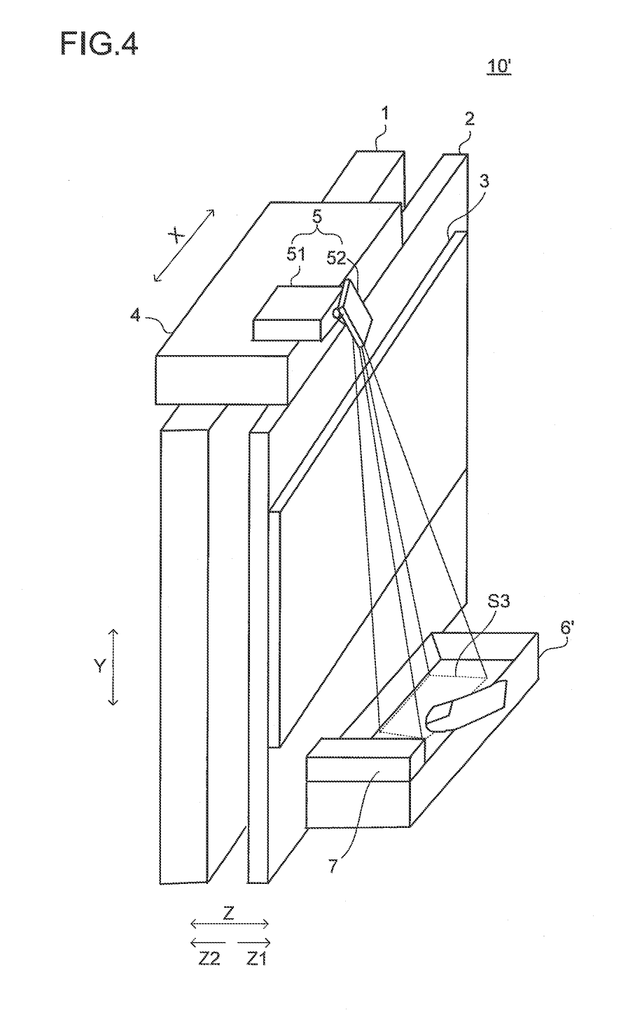

Next, as a modified example of the first embodiment described above, a second embodiment of the present invention will be described. In the second embodiment of the present invention, as in the pachinko machine 10′ shown in a schematic overall perspective view in FIG. 4, the tray 6′ is provided with a light detection unit 7.

The light detection unit 7 is arranged at one end of the tray 6′ in its long-side direction with a light-receiving surface of the light detection unit 7 pointing into the tray 6′.

As the reflective mirror 52A (FIG. 3) provided in the biaxial mirror unit 52 deflects, the image output from the video output unit 51 is projected on the bottom surface of the tray 6′ (projected image S3 in FIG. 4). When an obstacle, such as a finger, is put into the projected image region in the tray 6′, the laser light reflected from the reflective mirror 52A is reflected on the obstacle, and the reflected light is received by the light detection unit 7.

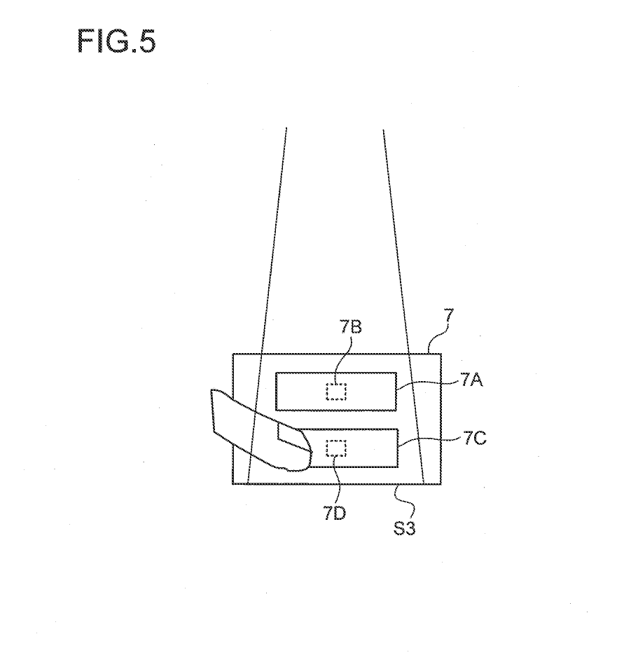

A view of the light detection unit 7 as seem from the side of its light-receiving surface is shown in FIG. 5. As shown in FIG. 5, the light detection unit 7 has a housing in which openings 7C and 7A are formed in an array in order of closeness to the projected image S3 in the height direction (the direction perpendicular to the projected image S3). Inside the housing, at a position corresponding to the opening 7A, a photodetector 7B is provided and, at a position corresponding to the opening 7C, a photodetector 7D is provided. Between the opening 7A and the photodetector 7B, and between the opening 7C and the photodetector 7D, unillustrated condenser lenses are provided one at each place.

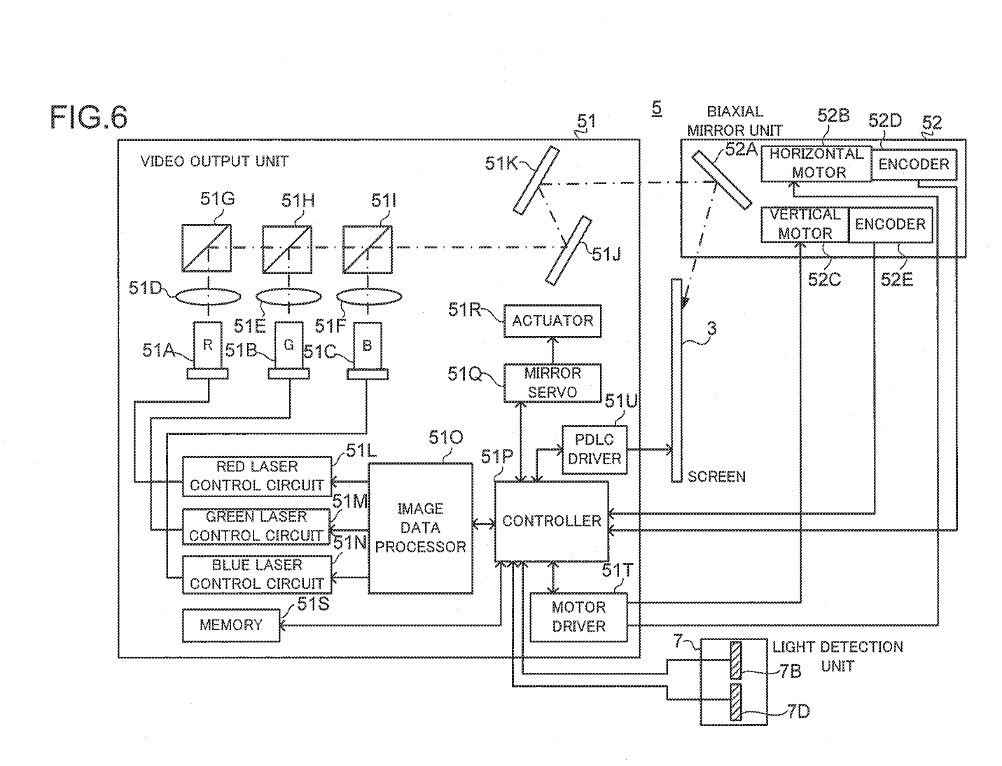

As shown in a block diagram in FIG. 6, the photodetectors 7B and 7D are each connected to the controller 51P in the video output unit 51.

Based on light detection signals output from the photodetectors 7B and 7D respectively when these receive the laser light reflected from an obstacle such as a finger, the controller 51P can detect an action in which projected image S3 projected on the tray 6′ is pushed in by the obstacle.

Based on the light detection signal output from the photodetector 7D corresponding to the opening 7C closer to projected image S3, and based on the horizontal and vertical synchronizing signals for driving the horizontal and vertical MEMS mirrors 51J and 51K at the time of the light detection, the controller 51P can also detect the coordinates (two-dimensional coordinates) of the position at which projected image S3 is pushed in by the obstacle.

For example, in a case where a button is displayed in projected image S3, and the video output unit 51P recognizes that the coordinates of the detected position fall at a particular display position, the pachinko machine is made to behave in a manner corresponding to the button operated. Thus, it is possible to realize a virtual input interface.

Although, in this embodiment, two photodetectors are provided, three or more photodetectors may instead be provided in an array in the height direction, or a single photodetector may instead be provided.

A photodetector may be provided near the outer edge of the screen 3 so that the photodetector receives the light resulting from the laser light emitted for projection on the screen 3 being reflected on an obstacle. Thus, it is possible to realize a virtual input interface by means of the image projected on the screen 3.

It should be understood that the embodiments by way of which the present invention has been described above allow for many modifications and variations within the spirit of the present invention.

For example, although the embodiments described above adopt a reflective screen, a transmissive screen may be used instead. In that case, the reflective mirror of the biaxial mirror unit is arranged with a rearward displacement from the transmissive screen (in the direction perpendicular to the projection surface), and the image is projected on the rear side of the screen.

Instead of a video output unit of a laser scanning type as in the embodiments described above, for example, a video output unit that projects video by use of a laser light source and LCOS (liquid crystal on silicon) may be used. Also with a video output unit like that, it is possible to eliminate defocus from the projected video.

Video projection devices can be applied to other than game machines. For example, a video projection device may be provided on a building or the like so that an image is projected on a wall surface of the building as a projection target.

What is claimed is:

1. A video projection device comprising:
a video output unit for outputting video by emitting light; and
a reflective mirror for reflecting the light emitted from the video output unit to project the video on a projection target, the reflective mirror being driven to rotate about two axes so as to move the reflected light in horizontal and vertical directions.

2. The video projection device according to claim 1, wherein the video output unit outputs the video by two-dimensionally scanning and emitting the light.

3. The video projection device according to claim 1, wherein
the video output unit outputs the video while refreshing frames, and
twice a number of revolutions per second of the reflective mirror in the horizontal and vertical directions is equal to or less than a refresh rate of the frames.

4. The video projection device according to claim 1, further comprising a corrector for correcting at least one of magnification, distortion, and brightness of the video output from the video output unit according to a projection position of the video.

5. The video projection device according to claim 4, wherein
the video output unit includes a horizontal mirror for scanning the emitted light in the horizontal direction and a vertical mirror for scanning the emitted light in the vertical direction, and
the corrector corrects at least one of the magnification and the distortion of the video by controlling deflection of the horizontal and vertical mirrors.

6. The video projection device according to claim 1, wherein
the video output unit includes a horizontal mirror for scanning the emitted light in the horizontal direction and a vertical mirror for scanning the emitted light in the vertical direction, and
the video projection device further comprises:
a light detector for detecting light reflected from the reflective mirror and then reflected from an obstacle; and
a position detector for detecting a position of the obstacle in the projected video based on horizontal and vertical synchronizing signals for driving the horizontal and vertical mirrors at a time that the light detector detects the light.

7. A video display device comprising:
the video projection device including a video output unit for outputting video by emitting light and a reflective mirror for reflecting the light emitted from the video output unit to project the video on a projection target, the reflective mirror being driven to rotate about two axes so as to move the reflected light in horizontal and vertical directions; and
a projection target arranged with a displacement, in a direction perpendicular to a projection surface, from a position of the reflective mirror provided in the video projection device.

8. The video display device according to claim 7, wherein the reflective mirror is arranged with a displacement from the projection target, which is of a reflective type, such that light reflected from the reflective mirror is incident on the projection surface.

9. The video display device according to claim 8, wherein
the projection target comprises elements arranged in a matrix and switchable between cloudy and transparent states, and
the video display device further comprises a driver for driving part of the elements into the cloudy state while changing the part within the matrix according to a position of the projected video.
